(19) United States
(12) Patent Application Publication
(10) Pub. No.: US 2013/0041606 A1
(43) Pub. Date: Feb. 14, 2013

(54) DETECTING AN OPEN WIRE BETWEEN A BATTERY CELL AND AN EXTERNAL CIRCUIT

(71) Applicants: Xiaohu TANG, Shanghai (CN); Guoxing LI, Sunnyvale, CA (US)

(72) Inventors: Xiaohu TANG, Shanghai (CN); Guoxing LI, Sunnyvale, CA (US)

(21) Appl. No.: 13/207,255

(22) Filed: Aug. 10, 2011

(51) Int. Cl. G06F 19/00; G01N 27/416

(52) U.S. Cl. 702/63; 324/433

(57) ABSTRACT

A device for detecting an open wire coupled to a battery includes a first pin and a second pin. The first pin is coupled to a positive terminal of a battery cell through a connection circuit. The second pin is coupled to a negative terminal of the battery cell through the connection circuit. A path of a current through the connection circuit changes in response to a wire between the connection circuit and the battery cell becoming open, and a change in a detecting voltage across the first pin and the second pin indicates a change in the path.

### BACKGROUND

There are various types of batteries, such as Lithium-Ion batteries and Lead-Acid batteries. A battery can include multiple battery cells. Each battery cell is typically connected to an external circuit for purposes such as charging, discharging or balancing. A wire connecting a battery cell and the external circuit may accidentally become open during charging, discharging or balancing, which may result in an unbalance condition of the battery and may damage the battery as a whole. As such, it is important to detect an open wire.

A conventional solution for detecting an open wire relies on voltage differences obtained through multiple voltage measurements. For example, when a voltage applied to a wire L1 connected to a battery cell BAT1 is measured as V1 at a first time and as V2 at a second time, the wire L1 is considered open if a voltage difference ΔV between the voltages V1 and V2 exceeds a threshold value, such as 200 mV.

However, the measured voltage difference is subject to interference/influence from the outside environment, e.g., noise or vibration. Therefore, reliance on the voltage difference to detect an open wire may be inaccurate or unreliable, and it is also inefficient because of the need to measure the voltage applied to the wire multiple times.

### SUMMARY

In one embodiment, a device for detecting an open wire coupled to a battery includes a first pin and a second pin. The first pin is coupled to a positive terminal of a battery cell through a connection circuit. The second pin is coupled to a negative terminal of the battery cell through the connection circuit. A path of a current through the connection circuit changes in response to a wire between the connection circuit and the battery cell becoming open and a change in a detecting voltage across the first pin and the second pin indicates a change in the path.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a chip for open-wire detection according to one embodiment of the present invention.

FIG. 2 illustrates a circuit for open-wire detection according to one embodiment of the present invention.

FIG. 3 illustrates a circuit for open-wire detection according to another embodiment of the present invention.

FIG. 4 illustrates a system for open-wire detection according to one embodiment of the present invention.

FIG. 5 is a flowchart of a method for open-wire detection of a battery according to one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments in accordance with the present invention provide devices, circuits and methods for open-wire detection. In one embodiment, a device for detecting an open wire coupled to a battery includes a first pin and a second pin. The first pin is coupled to a positive terminal of a battery cell through a connection circuit. The second pin is coupled to a negative terminal of the battery cell through the connection circuit. A path of a current through the connection circuit changes in response to a wire between the connection circuit and the battery cell becoming open and a change in a detecting voltage across the first pin and the second pin indicates a change in the path.

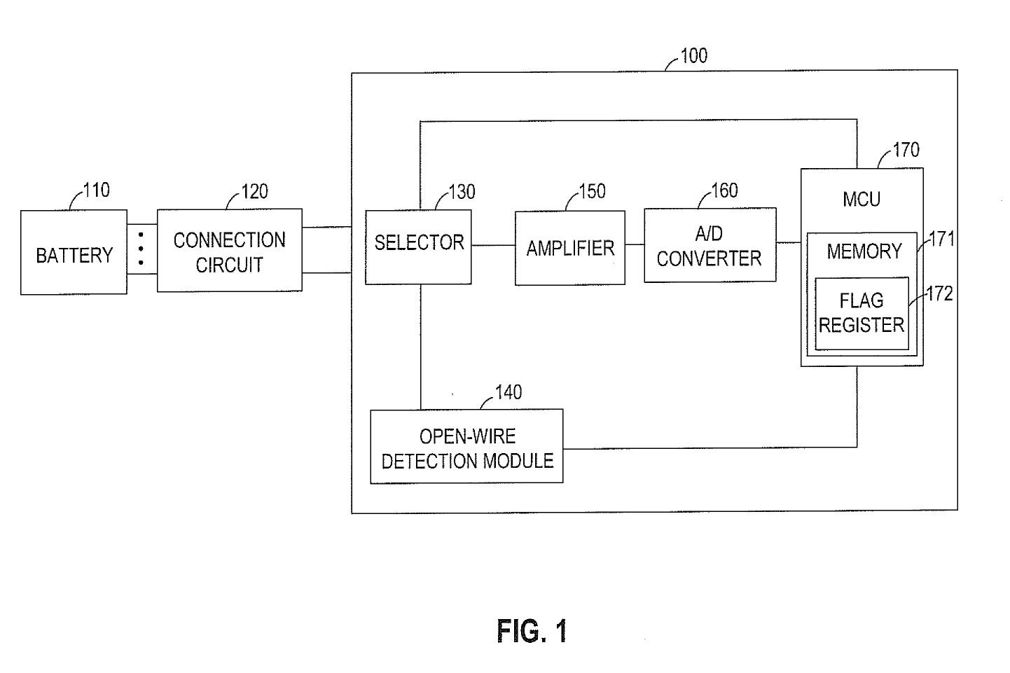

FIG. 1 illustrates a chip 100 for open-wire detection according to one embodiment of the present invention. In the example of FIG. 1, the chip 100 is coupled to a battery 110 through a connection circuit 120. The connection circuit 120 is connected to the battery cells in the battery 110 via a plurality of wires. The battery 110 can be, but is not limited to, a Lithium-Ion battery or Lead-Acid battery. In one embodiment, the chip 100 includes more than one pin, among which a first pin of the chip 100 is coupled to a positive terminal of a battery cell in the battery 110 through the connection circuit 120 and a second pin is coupled to a negative terminal of the battery cell in the battery 110 through the connection circuit 120. In one embodiment, the chip 100 includes a selector 130, an open-wire detection module 140, an amplifier 150, an analog/digital (A/D) converter 160 and a micro control unit 170 (MCU).

The selector 130 is coupled to the connection circuit 120 and selects a battery cell for open-wire detection. The open-wire detection module 140 is coupled to the selector 130 and generates a substantially constant current through the connection circuit 120 for a specified length of time. (Hereinafter, the substantially constant current may be referred to simply as a constant current. The use of “substantially constant current” means that some change in the current is permissible, as long as the change is not large enough to falsely indicate an open wire when one is not present.) According to embodiments of the invention, the current path of the constant current through the connection circuit 120 will change if the state of the connection circuit 120 changes. Specifically, the current path will change if a wire in the connection circuit 120 should become open (e.g., disconnected or damaged). A change in the current path of the constant current leads to a change in a detecting voltage measured across the pins coupled to the selected battery cell. As will be described further below, a single measurement of the detecting voltage can be used to determine whether a wire connected to the selected battery cell is open or not. As such, multiple measurements are not needed, in contrast to conventional techniques.

The amplifier 150 is coupled to the selector 130 to amplify the detecting voltage. The ND converter 160 is coupled to the amplifier 150 to convert the amplified detecting voltage from analog to a digital voltage reading. The MCU 170 is coupled to the selector 130, the open-wire detection module 140 and the ND converter 160, and compares the digital voltage reading with a specified range. If the voltage reading is outside the specified range, then an open-wire condition exists in the connection circuit 120. In one embodiment, the range is specified according to a working voltage range of each battery cell. In one embodiment, the MCU 170 further includes a memory 171 for storing the voltage reading. In one embodiment, the memory 171 further includes a flag register 172 for storing status flags indicating state information for the connection circuit 120. In one embodiment, the flag register 172 has multiple bits, where each bit of the flag register 172 corresponds to a wire in the connection circuit 120 and reflects the state of a respective wire—if a bit for a wire has one value, then that wire is considered to be open; otherwise, the wire is considered to be functioning satisfactorily.

Advantageously, because the chip 100 determines the state of each of the wires in the connection circuit 120 through a single measurement, the chip 100 operates in a more efficient way relative to conventional detection methods. In addition, a relatively wide range can be specified and applied to determine an open wire. Therefore, compared to conventional techniques, the chip 100 is able to detect an open wire more accurately and is not as acutely affected by the outside environment. Therefore, the chip 100 is better at protecting the battery 110 against damage.

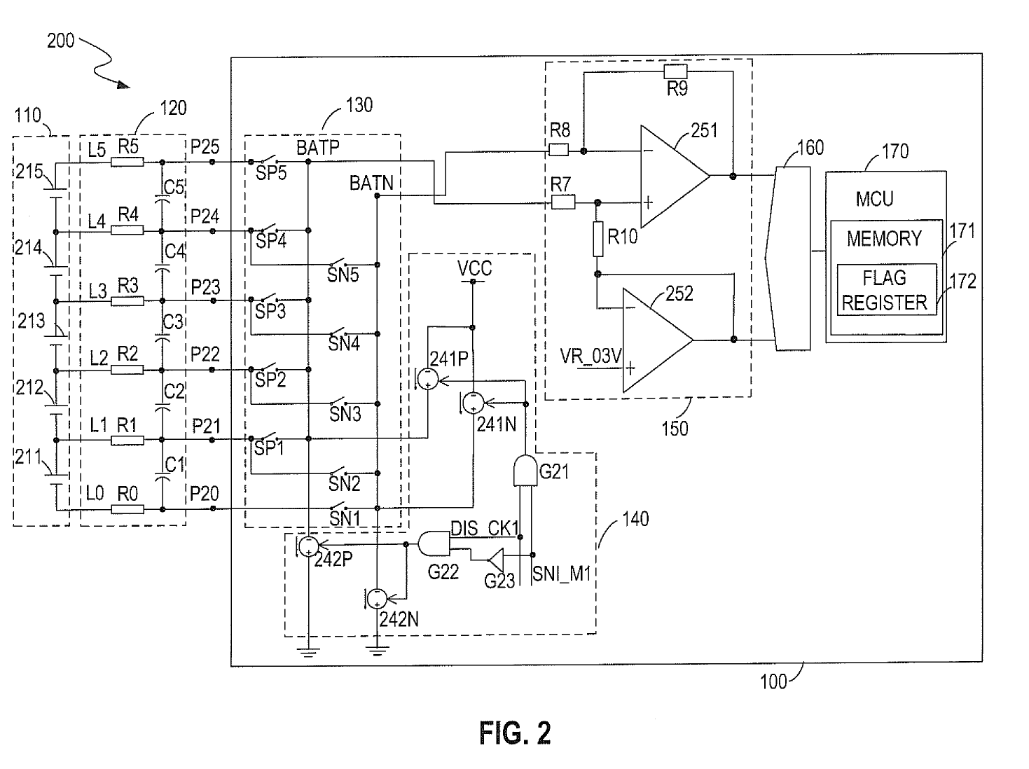

FIG. 2 illustrates a circuit 200 for open-wire detection according to one embodiment of the present invention. Elements labeled the same as in FIG. 1 have similar functions. In the example of FIG. 2, the chip 100 includes a plurality of pins P20-P25. The battery 110 includes battery cells 211-215 coupled in series. In one embodiment, a working voltage range of each battery cell is about 0-5V. The connection circuit 120 includes capacitors C1-05 coupled in parallel with the battery cells 211-215 via wires L0-L5, respectively. Each of the wires L0-L5 is coupled to a resistor, e.g., resistors R0-R5, respectively. In one embodiment, the capacity of each of the capacitors C1-05 is about 0.1 u.

The selector 130 is coupled to the connection circuit 120. In the example of FIG. 2, the selector 130 includes first switches SP1-SP5 and second switches SN1-SN5. Each first terminal of the first switches SP1-SP5 is coupled to a respective positive terminal of the battery cells 211-215 via the connection circuit 120. Each second terminal of the first switches SP1-SP5 is coupled to the amplifier 150. Each first terminal of the second switches SN1-SN5 is coupled to a respective negative terminal of the battery cells 211-215 via the connection circuit 120. Each second terminal of the second switches SN1-SN5 is coupled to the amplifier 150. In the example of FIG. 2, a conjunction node of the second terminals of the first switches SP1-SP5 and the amplifier 150 is referred to as a first node BATP, and a conjunction node of each second terminals of the second switches SN1-SN5 and the amplifier 150 is referred to as a second node BATN.

The open-wire detection module 140 includes two current sources 241P, 241N that each generates a respective source current, and two current sinks 242P, 242N that each generates a respective sink current. In one embodiment, the source currents and the sink currents are each about 500 uA. Power terminals of the current sources 241P, 241N are connected to a power supply VCC. Control terminals of the current source 241P, 241N receive a first control signal DIS_CK1 and a second control signal SN1_M1 through an AND gate G21. Ground terminals of the current sinks 242P, 242N are grounded. Control terminals of the current sinks 242P, 242N receive the first control signal DIS_CK1 through an AND gate G22, and receive the second control signal SN1_M1 through an inverting gate G23 and the AND gate G22. Output terminals of the current source 241P and the current sink 242P are coupled to the first node BATP. Output terminals of the current source 241N and the current sink 242N are coupled to the second node BATN.

The amplifier 150 is coupled to the selector 130. In one embodiment, the amplifier 150 includes a first operational amplifier 251 and a second operational amplifier 252. A non-inverting input terminal of the first operational amplifier 251 is coupled to the first node BATP through a resistor R7. An inverting input terminal of the first operational amplifier 251 is coupled to the second node BATN through a resistor R8, and is also coupled to an output terminal of the first operational amplifier 251 through a resistor R9 to provide negative feedback. A non-inverting input terminal of the second operational amplifier 252 receives a voltage signal VR_{—}03V. In one embodiment, the voltage signal VR_{—}03V has a voltage of about 0.3V. The inverting input terminal of the second operational amplifier 252 is coupled to the non-inverting input terminal of the first operational amplifier 251 through a resistor R10, and is also coupled to the output terminal of the second operational amplifier 252 to provide negative feedback. As in the example of FIG. 2, resistances of the resistors R7, R8 are equal to each other, and resistances of the resistors R9, R10 are also equal to each other. The ratio of the resistance of resistor R8 to the resistance of resistor R9 is about 2:1. The output terminals of the first operational amplifier 251 and the second operational amplifier 252 are coupled to the A/D converter 160. The ND converter 160 is also coupled to the MCU 170.

As discussed in relation to FIG. 1, the selector 130 selects a target battery cell from the battery cells 211-215. The open-wire detection module 140 generates a constant current. The connection circuit 120 provides different current paths for the constant current based upon a state of the connection circuit 120 coupled to the target battery cell. The connection circuit 120 further generates a detecting voltage that is determined based on the current path of the constant current. The amplifier 150 processes the detecting voltage. The ND converter 160 outputs a voltage reading based upon the detecting voltage. The MCU 170 compares the voltage reading with a range of about 0-5V, for example, thereby determining the state of the connection circuit 120. More specifically, for the target battery cell, if the detecting voltage is outside the specified range, then an open-wire state is indicated. Conversely, if the detecting voltage is inside the specified range, then an open-wire state is not indicated. Accordingly, a change in the detecting voltage, from a value that is inside the specified range to a value that is outside the specified range, would indicate an open-wire state. In one embodiment, the MCU 170 further sets a status flag (e.g., a corresponding bit) in the flag register 172 to reflect the state of the connection circuit 120. In one embodiment, each bit of the flag register 172 is set to a default value of zero (0), representing a connected wire. If, for the target battery cell, the voltage reading output by the A/D converter 160 is outside the specified range, indicating a wire in the connection circuit 120 is open, then the status flag corresponding to that wire is reset to a value of one (1) to indicate an open connection state for that wire. Otherwise, the status flag is not changed from the default value.

More specifically, in one embodiment, the battery cells 211-215 are selected for open-wire detection, proceeding from one end of the battery to the other (e.g., from bottom to top in the orientation of FIG. 2). In the example of FIG. 2, in the first stage of the open-wire detection process, the battery cell 211 is selected by the selector 130 to detect the states of the wires L0, L1 when the first switch SP1 and the second switch SN1 are switched on. Therefore, the pin P21 functions as the aforementioned first pin and the pin P20 functions as the aforementioned second pin. The current sources 241P, 241N provide a respective source current of, for example, about 500 uA each when the first control signal DIS_CK1 and the second control signal SN1_M1 are both set to a specified voltage level (e.g., High).

Assuming the wires L0, L1 are both connected to the battery cell 211, the source currents provided by the current sources 241P, 241N will flow through the resistors R0 and R1, respectively. Therefore, a voltage on the capacitor C1, which is equal to a cell voltage of the battery cell 211 prior to the sourcing of the source currents, will not change after the sourcing. Therefore, a detecting voltage across the pin P20 and the pin P21 also does not change. Accordingly, a voltage reading from the A/D converter 160 is within the specified range (e.g., 0-5V). Therefore, the MCU 170 will not reset the status flags in the flag register 172 corresponding to the wires L0, L1.

Assuming the wire L0 is open and the wire L1 is connected to the battery cell 211, the source current from the current source 241N will flow through the capacitor C1 and discharge the capacitor C1. As a result of discharging the capacitor C1, the voltage reading from the A/D converter 160 changes accordingly. If, for example, the source current is 500 uA, the capacity of the capacitor C1 is 0.1 u, and the cell voltage of the battery cell 211 is 4V, then the voltage across the capacitor C1 will change from about 4V to −6V after 2 ms of discharging. Consequently, a voltage level at the second node BATN will be higher than a voltage level at the first node BATP. Due to the voltage signal VR_{—} 03V at the non-inverting input terminal of the second operational amplifier 252, a voltage difference between the output terminals of the first operational amplifier 251 and the second operational amplifier 252 will be about −0.3V. Therefore, a voltage reading from the A/D converter 160 will be about −0.6V. The MCU 170 compares the voltage reading with the specified range (e.g., 0-5V). Because the output of the ND converter 160 is outside that range, a status flag corresponding to wire L0 is set to 1 in the flag register 172 to reflect that the wire L0 is open, while the status flag corresponding to wire L1 remains set to its default value.

Assuming the wire L1 is open and the wire L0 is connected to the battery cell 211, the source current provided by the current source 241P will charge the capacitors C1 while discharging the capacitor C2. As a result of charging capacitor C1, the voltage reading from the ND converter 160 changes accordingly. If, for example, the source current is 500 uA, the capacity of the capacitor C1 is 0.1 u, and the cell voltage of the battery cell 211 is 1V, then the voltage across the capacitor C1 will change from about 1V to 6V after 2 ms of charging. Therefore, a voltage difference between the output terminals of the first operational amplifier 251 and the second operational amplifier 252 will be about 3V. Therefore, a voltage reading from the A/D converter 160 will be about 6V. The MCU 170 compares the voltage reading with the specified range (e.g., 0-5V). Because the voltage reading is outside that range, a status flag corresponding to the wire L1 is set to 1 in the flag register 172 to reflect that the wire L1 is open, while the status flag corresponding to wire L0 remains set to its default value.

Assuming the wires L0, L1 are both open, the source currents will not flow through the capacitor C1. Therefore, a voltage on the capacitor C1 will not change. Therefore, the detecting voltage across the pin P20 and the pin P21 does not change either. Accordingly, a voltage reading from the A/D converter 160 is within the specified range (e.g., 0-5V). Therefore, the MCU 170 will not reset the status flags in the flag register 172 corresponding to the wires L0, L1. While it may appear that the chip 100 has failed to detect the open states of the wires L0, L1, this is not the case; the open states of the wires L0, L1 will be detected in a subsequent stage of the open-wire detection process, as described below.

In the next stage of the open-wire detection process, the battery cell 212 is selected by the selector 130 to detect the states of the wires L1, L2 when the first switch SP2 and the second switch SN2 are switched on. Therefore, the pin P22 functions as the aforementioned first pin and the pin P21 functions as the aforementioned second pin. The current sinks 242P, 242N provide a respective sink current of, for example, about 500 uA each when the first control signal DIS_CK1 is set to a first specified (higher) voltage level and the second control signal SN1_M1 is set to a second specified (lower than the first) voltage level.

Assuming the wires L1, L2 are both connected to the battery cell 212, the sink currents provided by the current sinks 242P, 242N will flow through the resistors R2 and R1, respectively. Therefore, a voltage on the capacitor C2, which is equal to a cell voltage of the battery cell 212 prior to the sinking of the sink current, will not change after the sinking. Therefore, a detecting voltage across the pin P22 and the pin P21 also does not change. Accordingly, a voltage reading from the ND converter 160 is within the specified range (e.g., 0-5V). Therefore, the MCU 170 will not reset the status flags in the flag register 172 corresponding to the wires L1, L2.

Assuming the wire L0 is connected to the battery cell 211, the wire L1 is open, and the wire L2 is connected to the battery cell 212, then the sink current provided by the current sink 242N will flow through the capacitors C1, C2 and discharge the capacitor C1 while charging the capacitor C2. As discussed above, the capacitor C2 is discharged in the previous stage of the open-wire detection process, when the battery cell 211 is selected for detection. When battery cell 212 is selected, a voltage change of the capacitor C2 resulting from discharging during the previous stage of the detection process will be compensated by charging during the current stage of the process. That is, the voltage across the capacitor C2 returns to normal and is equal to the voltage of the battery cell 211 prior to the sinking of the sinking currents. As a result, a voltage reading from the A/D converter 160 is within the specified range (e.g., 0-5V). Therefore, the MCU 170 will not reset the status flags in the flag register 172 corresponding to the wires L1, L2. Although the open state of the wire L1 would not be detected when the battery cell 212 is selected, the open state of the wire L1 would be detected when the battery cell 211 was selected in the preceding stage of the open-wire detection process, and the status flag corresponding to the wire L1 will have been set to 1 to reflect the open state and will not be reset.

Assuming the wires L0, L1 are both open and the wire L2 is connected to the battery cell 212, the sink source 242N will charge the capacitor C2. When the wires L0, L1 are both open, as discussed above, this condition will not be detected when the battery cell 211 is selected. However, the state of the wire L1 will be detected successfully when the battery cell 212 is selected. More specifically, as a result of the charging the capacitor C2, the voltage reading from the A/D converter 160 changes accordingly. If, for example, the sink current is 500 uA, the capacity of the capacitor C2 is 0.1 u, and the cell voltage of the battery cell 212 is about 1V, then the voltage across the capacitor C2 will change from about 1V to 6V after 2 ms of charging. Therefore, a voltage difference between the output terminals of the first operational amplifier 251 and the second operational amplifier 252 will be about 3V. Therefore, a voltage reading from the ND converter 160 will be about 6V. The MCU 170 compares the voltage reading with the specified range (e.g., 0-5V) and, because the output from the A/D converter 160 is outside that range, resets the proper status flag in the flag register 172 to 1 to reflect that the wire L1 is open. After the state of the wire L1 is detected, the state of the wire L0 can be determined accordingly.

Assuming the wires L0, L1 are connected to the battery cell 211 and the wire L2 is open, the sink current from the current sink 242P will flow through the capacitors C2, C3 and discharge the capacitor C2 while charging the capacitor C3. As a result of discharging the capacitor C2, the voltage reading from the A/D converter 160 changes accordingly. If, for example, the sink current is 500 uA, the capacity of the capacitor C2 is 0.1 u, and the cell voltage of the battery cell 212 is 4V, then the voltage across the capacitor C2 will change from about 4V to −6V after 2 ms of discharging. Consequently, a voltage level at the second node BATN will be higher than a voltage level at the first node BATP. Due to the voltage signal VR_{—}03V at the non-inverting input terminal of the second operational amplifier 252, a voltage difference between the output terminals of the first operational amplifier 251 and the second operational amplifier 252 will be about −0.3V. Therefore, a voltage reading from the ND converter 160 will be about −0.6V. The MCU 170 compares the voltage reading with the specified range (e.g., 0-5V) and, because the output of the ND converter 160 is outside that range, resets the appropriate status flag in the flag register 172 to 1 to reflect that the wire L2 is open.

In a similar manner, the battery cells 213-215 are individually selected for open-wire detection by switching on the appropriate first switch SP3, SP4, or SP5 and the appropriate second switch SN3, SN4, or SNS. For example, the MCU 170 resets the corresponding status flag in the flag register 172 to 1 to reflect that the wire L3 is open when a voltage reading based upon a detecting voltage across the pin P23 and the pin P22 is lower than the lowest limit of the specified range (e.g., 0-5V). The MCU 170 resets the corresponding status flag in the flag register 172 to 1 to reflect that the wire L2 is open when a voltage reading based upon a detecting voltage across the pin P23 and the pin P22 is higher than the highest limit of the specified range (e.g., 0-5V).

In one embodiment, the range applied to detect an open wire may be modified to be about 0.5-4.5V or 2-4.5V when the working voltage range of each battery cell is about 0.5-4.5V or 2-4.5V, respectively. Therefore, since the lowest limit of the range is higher than 0V, the voltage signal VR_{—}03V is unnecessary and the second operational amplifier 252 is omitted to save costs. For example, when the wire L3 is open, a voltage level at the second node BATN will be higher than a voltage level at the first node BATP. Therefore, a voltage reading output from the A/D converter 160 will be 0V, which is less than the lowest limit of the specified range (e.g., 0.5-4.5V or 2-4.5V).

As described above, the circuit 200 can detect the connection states of two wires connected to a selected battery cell at the same time. In one embodiment, the battery cells 211-215 are selected from bottom to top in sequence to detect the states of the wires L0-L5. In another embodiment, the battery cells 211-215 are selected from top to bottom in sequence to detect the states of the wires L0-L5 by modifying an enable sequence of the current sources 241P, 241N and the current sinks 242P, 242N through the control signals DIS_CK1 and SN1_M1. In yet another embodiment, the battery cells 211-215 can be selected in any order to detect the states of the wires connected to the selected battery cell. In another embodiment, the battery cells 211-215 are selected at random, and not all battery cells may be selected; for example, during one testing cycle, battery cell 213 may be selected, and in the next testing cycle, battery cells 212 and 214 are selected. A top wire (e.g., the wire L5) is detected by sinking a top battery cell (e.g., the battery cell 215) with the current sinks 242P and 242N, and a bottom wire (e.g., the wire L0) is detected by sourcing a bottom battery cell (e.g., the battery cell 211) with the current sources 241P and 241N.

Advantageously, the circuit 200 detects whether wires in the connection circuit 120 are connected or not to battery cells based on a single measurement per cell, by comparing the voltage reading based on the detecting voltage across a first pin and second pin with a predetermined range. Therefore, the circuit 200 can detect an open-wire condition reliably and efficiently.

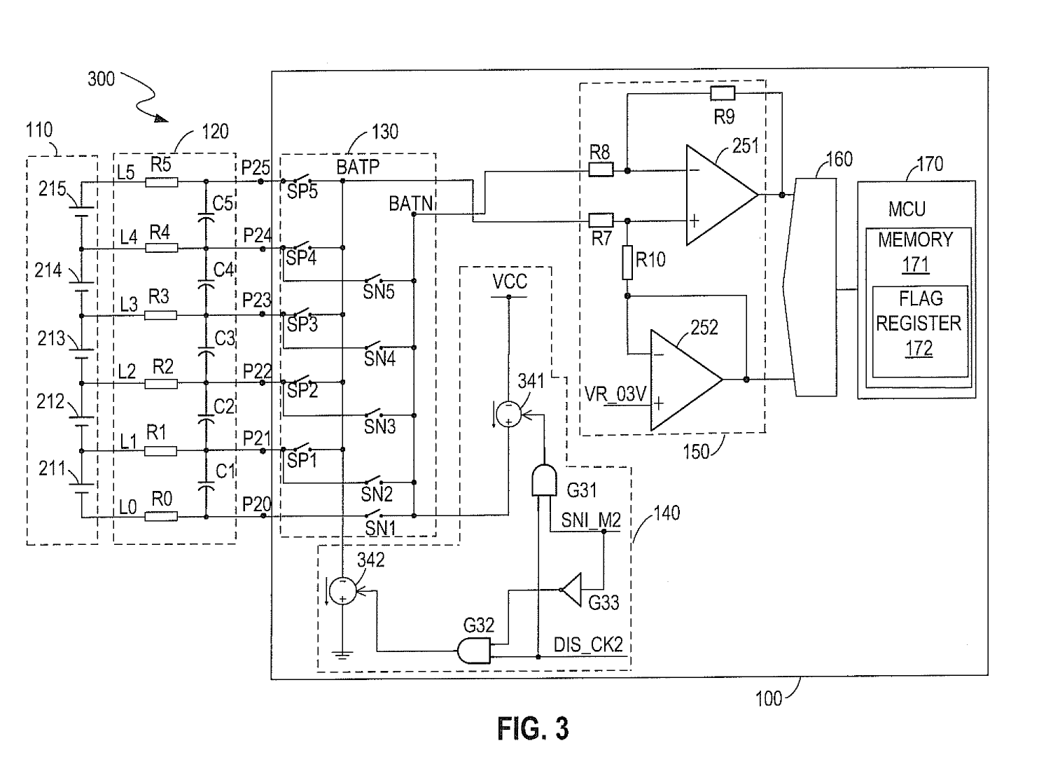

FIG. 3 illustrates a circuit 300 for open-wire detection according to one embodiment of the present invention. Elements labeled the same as in FIG. 1 and FIG. 2 have similar functions and configurations except as noted. Different from the FIG. 2 example, an open-wire detection module 140 in the example of FIG. 3 includes a current source 341 for generating a source current of, for example, about 500 uA, and a current sink 342 for generating a sink current of, for example, about 500 uA. A power terminal of the current source 341 is coupled to a power supply VCC. An output terminal of the current source 341 is coupled to the second node BATN. A control terminal of the current source 341 receives a first control signal DIS_CK2 and a second control signal SN1_M2 through a first AND gate G31. A ground terminal of the current sink 342 is grounded. An output terminal of the current sink 342 is coupled to the first node BATP. A control terminal of the current sink 342 receives the first control signal DIS_CK2 through a second AND gate G32, and receives the second control signal SN1_M2 through an inverting gate G33 and the second AND gate G23 in sequence.

More specifically, in one embodiment, the battery cells 211-215 are selected by the selector 130 from one end of the battery 110 to the other (e.g., from top to bottom considering the orientation of FIG. 3). In the example of FIG. 3, the battery cell 215 is firstly selected to detect the state of the wire L5 when the first switch SP5 and the second switch SN5 are switched on. Therefore, the pin P25 functions as the first pin referred to above, and the pin P24 functions as the second pin referred to above. The current sink 342 provides a sink current when the first control signal DIS_CK2 is set to a first voltage level and the second control signal SN1_M2 is set to a second, lower voltage level.

Assuming the wire L5 is connected to the battery cell 215, the sink current provided by the current sink 342 will flow through the resistor R5. Therefore, a voltage on the capacitor C5, which is equal to a cell voltage of the battery cell 215 prior to the sinking of the sink currents, will not change after the sinking. Therefore, the detecting voltage across the pin P25 and the pin P24 also does not change. Accordingly, a voltage reading from the ND converter 160 is within the specified range (e.g., 0-5V). Therefore, the MCU 170 will not reset the bit flag in the flag register 172 corresponding to the wire L5.

Assuming the wire L5 is open, the sink current generated by the current sink 342 will flow through the capacitor C5 and discharge the capacitor C5. As a result of discharging the capacitor C5, the voltage reading from the A/D converter 160 changes accordingly. If, for example, the sink current is 500 uA, the capacity of the capacitor C5 is 0.1 u, and the cell voltage of the battery cell 215 is 4V, then the voltage across the capacitor C5 will change from about 4V to −6V after 2 ms of discharging. Consequently, a voltage level at the second node BATN will be higher than a voltage level at the first node BATP. Due to the voltage signal VR_{—}03V at the non-inverting input terminal of the second operational amplifier 252, a voltage difference between the output terminals of the first operational amplifier 251 and the second operational amplifier 252 will be about −0.3V. Therefore, a voltage reading from the ND converter 160 will be about −0.6V. The MCU 170 compares the voltage reading with the specified range (e.g., 0-5V) and, because that voltage reading is outside that range, resets the status flag corresponding to the wire L5 to 1 in the flag register 172 to reflect that the wire L5 is open.

Next, the battery cell 214 is selected to detect the state of the wire L4 when the first switch SP4 and the second switch SN4 are switched on. Therefore, the pin P24 functions as the first pin referred to above and the pin P23 functions as the second pin referred to above. The current sink 342 provides a sink current of, for example, about 500 uA when the control signal DIS_CK2 is set to a first voltage level and the control signal SN1_M2 is set to a second, lower voltage level.

Assuming the wire L4 is connected to the battery cell 214, the sink current provided by the current sink 342 will flow through the resistor R4. Therefore, a voltage on the capacitor C4, which is equal to a cell voltage of the battery cell 214 prior to the sinking of the sink currents, will not change after the sinking. Therefore, the detecting voltage across the pin 24 and the pin P23 does not change either. Accordingly, a voltage reading from the ND converter 160 is within the specified range (e.g., 0-5V). Therefore, the MCU 170 will not reset the status flag in the flag register 172 corresponding to the wire L4.

Assuming the wire L4 is open, the sink current will flow through the capacitors C4, C5 and charge the capacitor C5 while discharging the capacitor C4. As a result of discharging capacitor C4, the voltage reading from the A/D converter 160 changes accordingly. If, for example, the sink current is 500 uA, the capacity of the capacitor C4 is 0.1 u, and the cell voltage of the battery cell 214 is 4V, then the voltage across the capacitor C4 will change from about 4V to −6V after 2 ms of discharging. Consequently, a voltage level at the second node BATN will be higher than a voltage level at the first node BATP. Due to the voltage signal VR_{—}03V at the non-inverting input terminal of the second operational amplifier 252, a voltage difference between the output terminals of the first operational amplifier 251 and the second operational amplifier 252 will be about −0.3V. Therefore, a voltage reading from the ND converter 160 will be about −0.6V. The MCU 170 compares the voltage reading with the specified range (e.g., 0-5V) and, because the voltage reading is outside that range, the status flag in the flag register 172 corresponding to wire L4 is reset to 1 to reflect that the wire L4 is open.

In a similar manner, each of the battery cells 211-213 is selected in sequence for open-wire detection by switching on the appropriate first switch SP1, SP2, or SP3 and the appropriate second switch SN1, SN2, or SN3, and the current sink 342 is enabled to provide a sink current to detect the state of the wires L1-L3.

Then, the battery cell 211 is selected for a second time by switching on the first switch SP1 and the second switch SN1 to detect the state of the wire L0. Therefore, the pin P21 still functions as the aforementioned first pin, and the pin P20 still functions as the aforementioned second pin. The current source 341 provides a source current of, for example, about 500 uA when the control signal DIS_CK2 and the control signal SN1_M2 are set to a specified voltage level (e.g., High).

Assuming the wire L0 is connected to the battery cell 211, the source current provided by the current source 341 will flow through the resistor R0. Therefore, a voltage on the capacitor C1 will not be changed. Therefore, a voltage on the capacitor C1, which is equal to a cell voltage of the battery cell 211 prior to the sourcing of the source currents, will not change after the sourcing. Therefore, the detecting voltage across the pin P20 and the pin P21 does not change either. Accordingly, a voltage reading from the ND converter 160 is within the specified range (e.g., 0-5V). Therefore, the MCU 170 will not reset the state flag in the flag register 172 corresponding to the wire L0.

Assuming the wire L0 is open, the source current provided by the current source 341 will flow through the capacitor C1 and discharge the capacitor C1. As a result of discharging the capacitor C1, the voltage reading from the A/D converter 160 changes accordingly. If, for example, the source current is 500 uA, the capacity of the capacitor C1 is 0.1 u, and the cell voltage of the battery cell 211 is 4V, then the voltage across the capacitor C1 will change from about 4V to −6V after 2 ms of discharging. Consequently, a voltage level at the second node BATN will be higher than a voltage level at the first node BATP. Due to the voltage signal VR_{—}03V at the non-inverting input terminal of the second operational amplifier 252, a voltage difference between the output terminals of the first operational amplifier 251 and the second operational amplifier 252 will be about −0.3V. Therefore, a voltage reading from the ND converter 160 will be about −0.6V. The MCU 170 compares the voltage reading with the specified range (e.g., 0-5V) and, because the voltage reading is outside that range, the status flag of the flag register 172 is reset to 1 to reflect that the wire L0 is open.

In one embodiment, the range used to detect an open-wire condition may be modified to be about 0.5-4.5V or 2-4.5V when the working voltage of each battery cell is about 0.5-4.5V or 2-4.5V, respectively. Therefore, since the lowest limit of the range is higher than 0V, the voltage signal VR_{—}03V is unnecessary and the second operational amplifier 252 is omitted to reduce costs. For example, when the wire L3 is open, a voltage level at the second node BATN will be higher than a voltage level at the first node BATP. Therefore, a voltage reading output from the ND converter 160 will be 0V and less than the lowest limit of the specified range (e.g., either 0.5-4.5V or 2-4.5V).

As such, the circuit 300 detects the state of the wires L0-L5 one-by-one. In one embodiment, the battery cells 211-215 are selected from top to bottom in sequence to detect the states of the wires L0-L5. In another embodiment, the battery cells 211-215 are selected from bottom to top in sequence to detect the states of the wires L0-L5 by modifying an enable sequence of the current source 341 and the current sink 342 through the control signals DIS_CK2 and SN1_M2. In yet another embodiment, the battery cells 211-215 can be selected in any order to detect the state of a wire connected to the selected battery cell. A top wire (e.g., the wire L5) is detected by sinking a top battery cell (e.g., the battery cell 215) with the current sink 342, and a bottom wire (e.g., the wire L0) is detected by sourcing a bottom battery cell (e.g., the battery cell 211) with the current source 341.

Advantageously, the circuit 300 detects whether a wire is connected to a battery cell based on a single measurement per cell, by comparing the detecting voltage across the first pin and second pin with a specified range. Therefore, the circuit 300 can reliably and efficiently detect an open-wire condition.

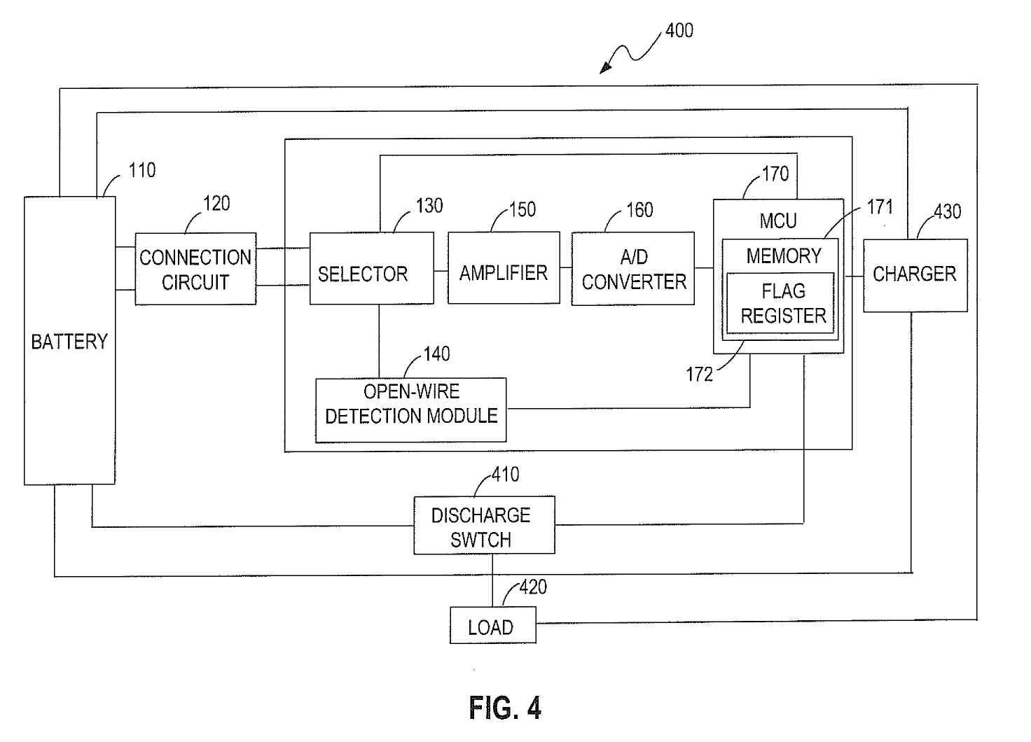

FIG. 4 illustrates a system 400 for open-wire detection according to one embodiment of the present invention. Elements labeled the same as in FIGS. 1, 2 and 3 have similar functions. The system 400 includes a discharge switch 410. The discharge switch 410 is coupled to the battery 110, and a load 420 is coupled between the discharge switch 410 and the battery 110. The discharge switch 410 controls discharging of the battery 110 under control of the MCU 170. In one embodiment, the discharge switch 410 is a metal-oxide-semiconductor-field-effect-transistor (MOSFET). In one embodiment, a charger 430 is coupled to the battery 110. The charger 430 charges the battery 110 under control of the MCU 170.

As discussed in relation to FIGS. 1, 2 and 3, the MCU 170 determines whether a connection between a wire and a battery cell in the battery 110 is open or not. In response to determining that an open-wire condition exists, the MCU 170 performs protective actions. For example, if an open-wire condition is identified during charging, discharging or balancing, the system 400 isolates the circuits associated with the charging, discharging or balancing to prevent the battery 110 from being damaged.

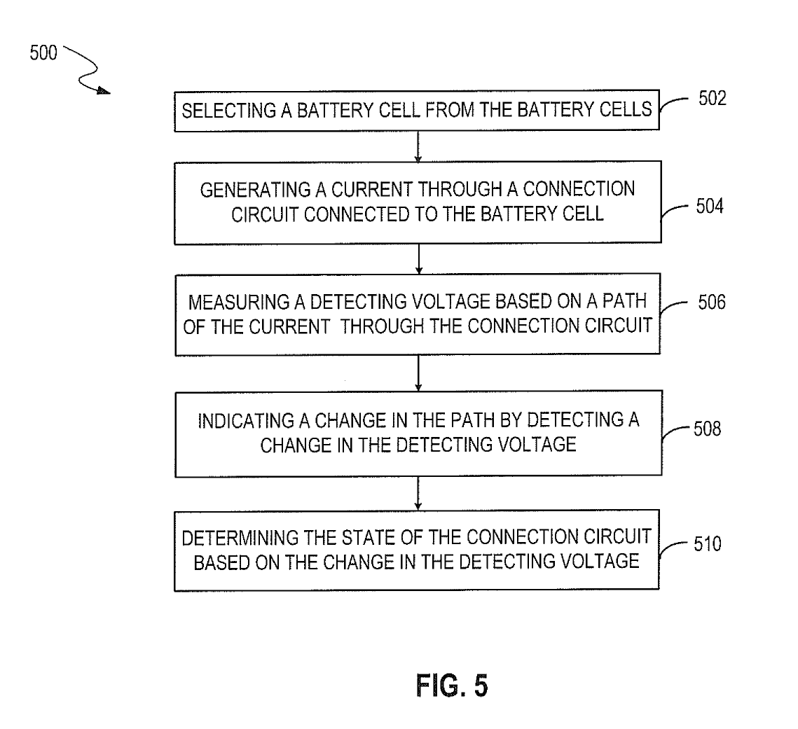

FIG. 5 illustrates a flowchart 500 of a method for open-wire detection according to one embodiment of the present invention. In one embodiment, the operations described in the flowchart 500 are performed by the chip 100. FIG. 5 is described in combination with FIGS. 1, 2 and 3. Although specific steps are disclosed in FIG. 5, such steps are examples. That is, the present invention is well suited to performing various other steps or variations of the steps recited in FIG. 5.

In block 502, a selector selects a battery cell (e.g., battery cell 213) in the battery for open-wire detection. In one embodiment, the first switch SP3 and the second switch SN3 of the selector 130 are switched on. Therefore, the pin P23 functions as the first pin mentioned above, and the pin P22 functions as the second pin mentioned above. Therefore, the battery cell 213 is selected for open-wire detection.

In block 504, an open-wire detection module generates a constant current. During a specified time period, the constant current flows through a connection circuit that is connected to the battery cell. In one embodiment, the current sinks 242P, 242N of the open-wire detection module 140 are enabled to generate a respective sink current of, for example, about 500 uA each to flow through the connection circuit 120 when the first control signal DIS_CK1 is set to a first voltage level and the second control signal SN1_M1 is set to a second, lower voltage level.

In block 506, a detecting voltage is measured when the constant current flows through the connection circuit connected to the battery cell. In one embodiment, a detecting voltage across the pin P23 and the pin P22 is generated when the sink currents flow through the connection circuit 120 connected to the battery cell 213.

In block 508, a change in the value of the detecting voltage indicates whether or not the wire is properly connected to the battery cell. In one embodiment, when the wire L1 is connected to the battery cell 212, the wire L2 is open, and the wire L3 is connected to the battery cell 213, the constant sink current provided by the current sink 242N will flow through the capacitors C2, C3 and discharge the capacitor C2 while charging the capacitor C3. As a result of charging the capacitor C3, the voltage reading from the A/D converter 160 changes accordingly. If, for example, the sink current is 500 uA, the capacity of the capacitor C3 is 0.1 u, and the cell voltage of the battery cell 213 is 1V, then the voltage across the capacitor C3 will change from about 1V to 6V after 2 ms of charging. Therefore, a voltage difference between the output terminals of the first operational amplifier 251 and the second operational amplifier 252 will be about 3V. Therefore, a voltage reading from the A/D converter 160 will be about 6V. When the wires L1, L2 are connected to the battery cell 212 and the wire L3 is open, the sink current provided by the current sink 242P will flow through the capacitors C3, C4 and discharge the capacitors C3 while charging the capacitor C4. As a result of discharging the capacitor C3, the voltage reading from the A/D converter 160 changes accordingly. If, for example, the sink current is 500 uA, the capacity of the capacitor C3 is 0.1 u, and the cell voltage of the battery cell 213 is 4V, the voltage across the capacitor C3 will change from about 4V to −6V after 2 ms of discharging. Consequently, a voltage level at the second node BATN will be higher than a voltage level at the first node BATP. Due to the voltage signal VR_{—}03V at the non-inverting input terminal of the second operational amplifier 252, a voltage reading from the ND converter 160 will be about −0.6V.

In block 510, an MCU determines the state of the connection circuit connected to the battery cell. In one embodiment, the MCU 170 compares the voltage reading output from the ND converter 160 to a specified range and, if the voltage reading is outside that range, then the status flag for an open wire is reset to 1 in the flag register 172 to reflect that the wire is open. In one embodiment, the MCU 170 also stores the voltage reading in the memory 171. In one embodiment, the flag register 172 has multiple bits, one bit per wire, to indicate the state of each of the wires.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A device for detecting an open wire coupled to a battery, said device comprising:
a first pin coupled to a positive terminal of a battery cell through a connection circuit; and
a second pin coupled to a negative terminal of said battery cell through said connection circuit, wherein a path of a current through said connection circuit changes in response to a wire between said connection circuit and said battery cell becoming open, and wherein a change in a detecting voltage across said first pin and said second pin indicates a change in said path.

2. The device of claim 1, wherein said connection circuit comprises a capacitor coupled in parallel with said battery cell.

3. The device of claim 1, further comprising a selector coupled to said connection circuit via said first pin and said second pin, wherein said selector selects said battery cell from a plurality of battery cells in said battery.

4. The device of claim 1, further comprising an amplifier coupled to said selector to amplify said detecting voltage.

5. The device of claim 1, further comprising an ND converter coupled to said connection circuit that outputs a voltage reading based on said detecting voltage and that converts said voltage reading from analog to digital.

6. The device of claim 1, further comprising a micro control unit (MCU) that compares said detecting voltage with a range, wherein said wire is indicated as being open if said detecting voltage is outside said range.

7. The device of claim 1, further comprising a memory for storing a voltage reading that is based on said detecting voltage, wherein said memory further comprises a flag register for storing a status flag that indicates whether said wire is open.

8. The device of claim 1, further comprising an open-wire detection module coupled to said connection circuit and operable for generating said current.

9. A circuit for detecting open wires coupled to a plurality of battery cells, said circuit comprising:
a selector coupled to said plurality of battery cells and operable for selecting a target battery cell from said battery cells;
an open-wire detection module coupled to said selector and operable for generating a current;
a connection circuit including a plurality of wires coupled between said battery cells and said selector and providing a plurality of paths for said current based on states of said wires, wherein said connection circuit further generates a detecting voltage that is based on a path of said current through said connection circuit; and
a micro control unit (MCU) coupled to said open-wire detection module and said selector and operable for determining an state of a wire based on said detecting voltage.

10. The circuit of claim 9, wherein said connection circuit comprises a capacitor coupled in parallel with said battery cell.

11. The circuit of claim 9, wherein said selector comprises a plurality of first switches and a plurality of second switches.

12. The circuit of claim 9, further comprising an amplifier coupled to said selector to amplify said detecting voltage.

13. The circuit of claim 12, further comprising an ND converter coupled to said amplifier that outputs a voltage reading based on said detecting voltage and converts said voltage reading from analog to digital.

14. The circuit of claim 9, wherein said MCU further comprises a memory for storing a voltage reading based on said detecting voltage.

15. The circuit of claim 9, wherein said MCU comprises a flag register for storing status flags that indicate said states of said wires.

16. The circuit of claim 9, wherein said open-wire detection module comprises a current source and a current sink.

17. A method for detecting open wires coupled to a plurality of battery cells, said method comprising:
selecting a target battery cell from said battery cells;
generating a current through a connection circuit connected to said target battery cell;
measuring a detecting voltage that is based on a path of said current through said connection circuit;
indicating a change in said path by detecting a change in said detecting voltage; and
determining whether a wire in said connection circuit is open based on said change in detecting voltage.

18. The method of claim 17, further comprising:
processing said detecting voltage to output a voltage reading; and
comparing said voltage reading with a voltage range to determine whether said wire is open.

19. The method of claim 17, further comprising converting said detecting voltage in analog to said voltage reading in digital.

20. The method of claim 17, further comprising storing a status flag that indicates whether said wire is open.
